(19) United States
(12) Patent Application Publication
(10) Pub. No.: US 2023/0031573 A1
(43) Pub. Date: Feb. 2, 2023

(54) Linear Plunger Valve

(71) Applicant: Jonathan Gentry Ambs, Jonesboro, AR (US)

(72) Inventor: Jonathan Gentry Ambs, Jonesboro, AR (US)

(73) Assignee: Jonathan Ambs, Jonesboro, AR (US)

(21) Appl. No.: 17/878,604

(22) Filed: Aug. 1, 2022

Related U.S. Application Data
(60) Provisional application No. 63/228,293, filed on Aug. 2, 2021.

(51) Int. Cl. F41B 11/723; F16K 11/07

(52) U.S. Cl. CPC F41B 11/723; F16K 11/0712

(57) ABSTRACT

A means of creating a novel, balanced, plunger valve. It is designed by combining the valve seats with the valve stem by varying the diameter of the valve stem. While the valve is closed it experiences minimal net force, but once opened, the working fluid assists in minimizing the response time of the valve. This creates a very efficient dump valve. The design limits the number of components needed for the valve to be assembled which reduces the cost, simplifies the maintenance, enhances the strength, and creates a more reliable valve. The following includes several methods of accomplishing this.

### CROSS-REFERENCE TO RELATED APPLICATIONS

This application claims the benefits of provisional patent application No. 63/228,293 filed 2021 August 2 by the present inventor.

### BACKGROUND-FIELD

This application relates to a novel valve that simplifies the design by combining the valve seats with the valve stem, decreasing the number of required parts, simplifying construction and maintenance, and enhancing performance.

### BACKGROUND—PRIOR ART

There are many types of valves for different uses. The original purpose of this invention was for air guns, but there are many other uses for the valve. Due to the broad scope, this section will focus on valves used in air guns. Most repeating pre-charged pneumatic air guns (PCP) use a hammer actuated valve. These valves are complicated to build, and each shot experiences a different pressure pulse due to the change in the pressure remaining in the tank. They also provide complex geometries that impede the flow of air that accelerates the projectile.

There have been other designs that attempt to construct a PCP air gun without using a hammer actuated valve. GB2466118A envisions a discharge valve that is biased towards opening and is held shut by a latch that is activated by a trigger. U.S. Pat. No. 4,865,009A envisions an air gun that utilizes a discharge chamber that is filled to a preset pressure. The valve in this patent also requires a separate trigger to open it.

All of these valves have complex designs with multiple moving parts. The number of parts, increases the likelihood of failure, increases the cost of manufacturing the valve, and decrease the efficiency.

### SUMMARY

This application relates to a novel plunger valve that utilizes two or more major diameters connected to a valve stem that act as valve seats to seal the valve ports. These major diameters may have the same diameter or a different diameter. It can be designed to use the fluid to assist the valve in rapidly opening or remain balanced during its operation. It is ideally suited for a dump valve where the fluid assists in opening the valve when it is open. This can be utilized by an air gun, where the gun may be fired by pulling on the valve stem allowing the trigger mechanism to be eliminated. It can also be designed to operate as a balanced valve that experiences almost 0 net force regardless of its configuration. It minimizes the number of pieces needed to construct the valve while maintaining excellent strength.

### DRAWINGS—FIGURES

FIG. 1. Illustrates a linear plunger valve in the rapid opening configuration incorporated with an air gun prior to the gun being fired.

FIG. 2. Illustrates a linear plunger valve in the rapid opening configuration incorporated with an air gun immediately after the gun has been fired.

FIG. 3. Illustrates a 3-2 linear plunger valve in the rapid opening configuration with the valve open.

FIG. 4. Illustrates a 3-2 linear plunger valve in the rapid opening configuration with the valve closed

FIG. 5. Illustrates a linear plunger valve that is closed in the balanced configuration.

FIG. 6. Illustrates a linear plunger valve that is open in the balanced configuration.

FIG. 7. Illustrates a 3-2 linear plunger valve that is closed in the balanced configuration.

### DETAILED DESCRIPTION

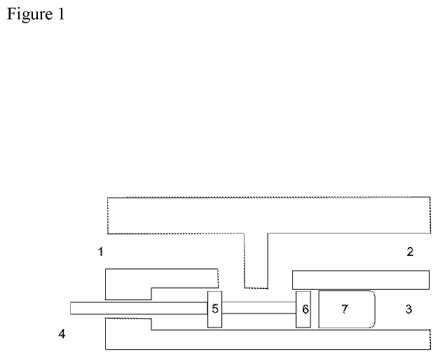

FIG. 1 represents the most basic concept of a rapid opening three-way linear piston valve. Three ports are contained in this valve: the left port (1), the upper right port (2), and the lower right port (3). The left port (1) is open to the right port (2) allowing the fluid to freely flow between the two. The valve stem (4) has a minor diameter that can be pulled backwards or pushed forward. It additionally has two major diameters (labeled in the illustration as (5) and (6)) that form a seal with the body of the valve and prevent the flow of fluid past them; sealing the lower right port (3).

If the valve was used with an air rifle, a projectile (7) could be placed immediately in front of the valve stem's (4) second major diameter (6). The main air tank would be connected to the left port (1), and the dump tank would be connected to the upper right port (2).

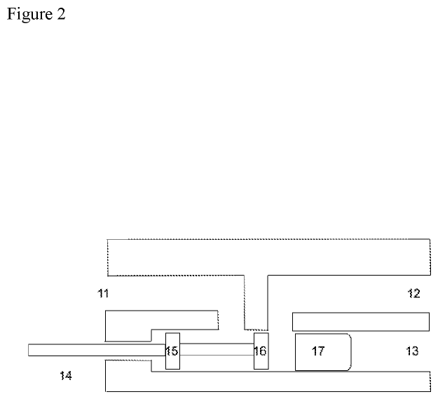

In FIG. 2, the valve stem (14) has been pulled to the rear. This causes the valve's right major diameter (16) to separate the left port (11) from the upper right port (12) and lower right port (13). The upper right port (12) and the lower right port (13) are now able to freely exchange fluid with each other. The valve's left major diameter (15) would prevent the fluid in the left port (11) from escaping out of the rear. If the valve was used with an air rifle, the projectile (17) would be accelerated by the compressed air stored in the dump tank (12).

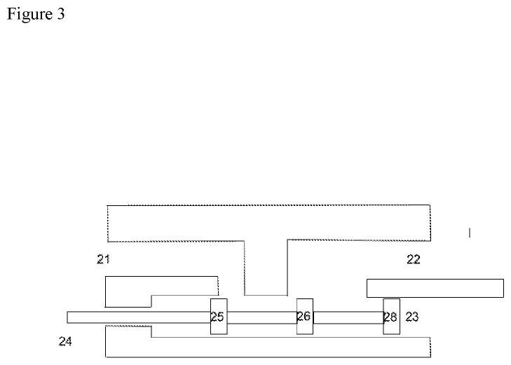

In FIG. 3, there are three major diameters (25, 26, and 28) connected to the valve stem (24) which is in the forward position. The left most major diameter (25) prevents the loss of fluid through the rear of the valve stem. The middle major diameter (26) is in the forward position, and it allows fluid to flow between the left port (21) and the upper right port (22). When the stem is in the forward position, the right most major diameter (28) prevents fluid from flowing through the lower right port (23).

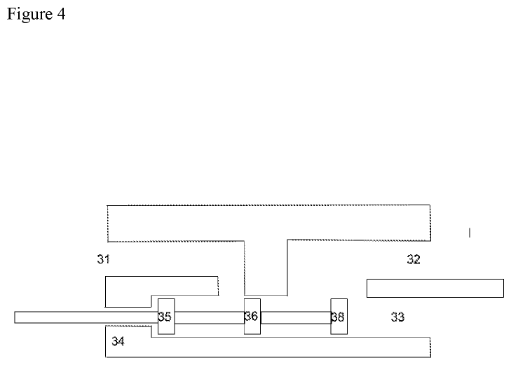

In FIG. 4, there are three major diameters (35, 36, and 38) connected to the valve stem (34) which is in the rear position. The left most major diameter (35) prevents the loss of fluid through the rear of the valve stem. The middle major diameter (36) is in the rear position, and it blocks fluid from the left port (31) to the upper right port (32) and lower right port (33). When the stem is in the rear position, the right most major diameter (38) allows fluid to flow between the upper right port (32) and the lower right port (33).

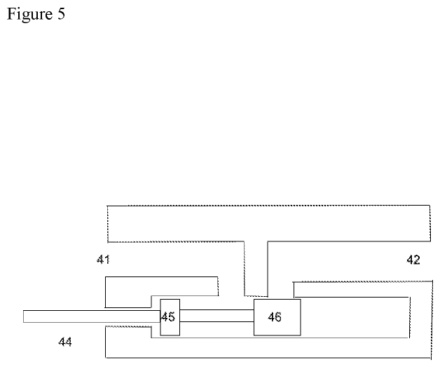

In FIG. 5, there are two major diameters (45 and 46) connected to the valve stem (44) which is in the rear position. The left major diameter (45) prevents the loss of fluid through the rear of the valve stem. The left port (41) can not exchange fluid with the right port (42) due to the right major diameter (46). Because of this, the valve is said to be in the closed position.

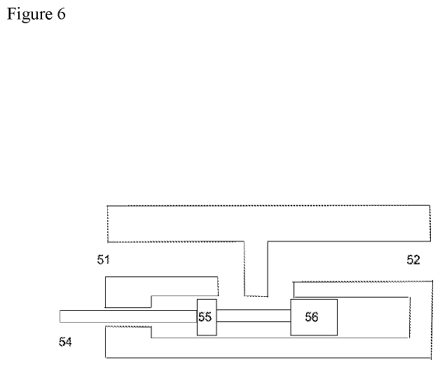

In FIG. 6, there are two major diameters (55) and (56) connected to the valve stem (54) which is in the forward position. The left major diameter (55) prevents the loss of fluid through the rear of the valve stem. The left port (51) can exchange fluid with the right port (52) due to the right major diameter (56) being forward. Because of this, the valve is said to be in the open position.

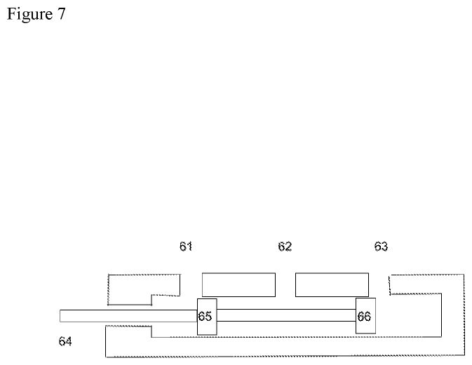

In FIG. 7, there are two major diameters (65) and (66) connected to the valve stem (64) which is in the neutral position. The left major diameter (65) prevents the loss of fluid through the rear of the valve stem and the right major diameter (66) prevents the loss of fluid through the front of the valve stem. The middle port (62) can not exchange fluid with the left port (61) due to the left major diameter. If the stem is pulled to the rear, the left major diameter will still prevent the loss of fluid through the rear of the valve stem, but the middle port (62) will freely exchange fluid with the left port (61). The middle port (62) can not exchange fluid with the right port (63) due to the right major diameter (66). If the stem is pushed forward, the right major diameter (66) will still prevent the loss of fluid through the front of the valve stem, but the middle port (62) will freely exchange fluid with the right port (63).

Advantages

From the description above, a number of advantages are evident:
a. By utilizing a rapid opening linear plunger valve, a simple valve can be constructed where the fluid assists the valve in rapidly opening.
b. By utilizing a rapid opening linear plunger valve, a simple and reliable air gun can be made with the trigger integrated into the valve.
c. By utilizing a balanced linear plunger valve, a single, strong, reliable valve can be constructed.

Conclusion Ramification and Scope

Thus the reader will see that a linear piston valve is a simple and reliable valve that is easy to open with a minimal response time. This valve can be easily integrated into an air gun. While the above description contains specifications and examples, these should not be construed as limiting the scope of any embodiment, but as an exemplification of the presently preferred embodiments thereof. The valve could also be utilized in many pneumatic and hydraulic applications. Many other ramifications and variations are possible within the teachings of the various embodiments. Thus the scope of the invention should be determined by the appended claims and their legal equivalents, and not by the examples given.

1. A valve system comprising:
a. a valve body;
b. a valve stem;
c. at least one major diameter on the stem that acts as the valve seat with the valve body sealing the fluid escaping from the rear;
d. at least one major diameter on the stem that acts as the valve seat with the valve body sealing the fluid escaping from the front;
e. At least one stem position where the major diameters on the stem prevent the flow of the fluid between the ports.
f. At least one stem position where the major diameters on the stem allow the flow of the fluid between the ports.

2. A valve system as set forth in claim 1 that is utilized by an air rifle where the stem operates as a trigger.

3. A valve system as set forth in claim 1 that utilizes three or more major diameters to create valves that can control the flow between multiple ports.

4. A valve system as set forth in claim 1 that utilizes different diameters for the major diameters to adjust the balance of the valve.

5. A valve system as set forth in claim 1 that is utilized by an air rifle where the stem is pulled or pushed by a device connected to a separate trigger.

6. A valve system as set forth in claim 1 that utilizes a solenoid or a screw to open and close the valve.

7. A valve system as set forth in claim 1 that utilizes a flexible or jointed section of the stem so the valve can be operated in an angle that is not parallel to the direction of the valve.

8. A valve system as set forth in claim 1 that utilizes a major diameter that does not form a complete seal so that the flow of fluid between the major diameters.
